(19) United States
(12) Patent Application Publication
(10) Pub. No.: US 2026/0358799 A1
(43) Pub. Date: Nov. 12, 2026

(54) PARKING SUPPORT SYSTEM

(71) Applicant: TOYOTA JIDOSHA KABUSHIKI KAISHA, Toyota-shi (JP)

(72) Inventors: Tatsuya SUGANO, Seto-shi (JP); Takahiro Yamamoto, Toyota-shi (JP); Chenyang Wang, Nagoya-shi (JP)

(73) Assignee: TOYOTA JIDOSHA KABUSHIKI KAISHA, Toyota-shi (JP)

(21) Appl. No.: 19/642,835

(22) Filed: Apr. 9, 2026

(30) Foreign Application Priority Data
May 12, 2025 (JP) 2025-079488

(51) Int. Cl. G05D 1/224; B60W 30/06

(52) U.S. Cl. CPC G05D 1/2246; B60W 30/06

(57) ABSTRACT

A parking support system configured to execute first parking support control of storing, as a registered route, a movement route when causing a vehicle to enter or exit a parking area by a user, and autonomously driving the vehicle along the registered route when causing the vehicle to enter or exit the parking area in next and subsequent times, and second parking support control of autonomously driving the vehicle along a target route in response to an operation of a portable terminal of the user to cause the vehicle to enter or exit the parking area, in which the registered route is stored in association with identification information, when a use request from the user is received, the second parking support control is executed by using the registered route, and when the use request is received, the identification information is displayed on a screen of the portable terminal.

### CROSS-REFERENCE TO RELATED APPLICATION

This application claims priority to Japanese Patent Application No. 2025-079488 filed on May 12, 2025. The disclosure of the above-identified application, including the specification, drawings, and claims, is incorporated by reference herein in its entirety.

### BACKGROUND

### 1. Technical Field

The present disclosure relates to a parking support system.

### 2. Description of Related Art

A route storage type parking support system is known (for example, see Japanese Unexamined Patent Application Publication No. 2024-115676 (JP 2024-115676 A)). The route storage type parking support system stores, as a registered route, a movement route of a vehicle in a case of causing the vehicle to enter a parking area that is predetermined or exit the parking area by a manual operation of a user, and autonomously drives the vehicle along the registered route in a case of causing the vehicle enter the same parking area or exit the same parking area in the next and subsequent times.

### SUMMARY

A so-called remote parking support system in which a user remotely operates a vehicle using a portable terminal to cause the vehicle to enter a parking area that is predetermined or exit the parking area is known. In a vehicle including such a remote parking support system and the route storage type parking support system, using the registered route stored in the route storage type parking support system as a target route of the remote parking support system is considered. However, in the remote parking support system, since the target route is displayed on the portable terminal, there is a problem that the amount of data of wireless communication increases in a case where the registered route stored in the route storage type parking support system is displayed. That is, simplifying information on the registered route stored in the route storage type parking support system such that the user can effectively understand the information on the portable terminal is desirable.

The present disclosure can effectively present the information on the registered route to the user in a case where the registered route stored in the route storage type parking support system is used as the target route of the remote parking support system.

A technology of the present disclosure relates to a parking support system configured to execute
first parking support control of storing, as a registered route, a movement route of a vehicle in a case of causing the vehicle to enter a parking area that is predetermined or exit the parking area by a manual operation of a user, in association with the parking area, and autonomously driving the vehicle along the registered route in a case of causing the vehicle to enter the parking area or exit the parking area in next and subsequent times to cause the vehicle to autonomously enter or exit the parking area, and
second parking support control of autonomously driving the vehicle along a target route in response to an operation of a portable terminal of the user to cause the vehicle to autonomously enter the parking area or autonomously exit the parking area, in which
the registered route is stored in association with identification information with which the user is able to identify the parking area,
in a case where a use request for the registered route from the user is received in a case where the user causes the vehicle to enter the parking area or exit the parking area by the second parking support control, the second parking support control is executed by using the registered route as the target route, and
in a case where the use request from the user is received, the identification information is displayed on a screen of the portable terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a hardware configuration of a parking support system according to the present embodiment;

FIG. 2 is a schematic diagram showing a software configuration of the parking support system according to the present embodiment;

FIG. 3A is a schematic diagram showing an example of a movement route according to the present embodiment;

FIG. 3B is a schematic diagram showing an example of the movement route according to the present embodiment;

FIG. 4 is a schematic diagram showing an example of a power operation screen according to the present embodiment;

FIG. 5 is a schematic diagram showing an example of an exit plan selection screen according to the present embodiment;

FIG. 6 is a schematic diagram showing an example of a target route in a case of exiting according to the present embodiment;

FIG. 7 is a schematic diagram showing an example of an exit plan confirmation screen according to the present embodiment;

FIG. 8 is a schematic diagram showing an example of an exit operation screen according to the present embodiment;

FIG. 9 is a schematic diagram showing an example of an exit end confirmation screen according to the present embodiment;

FIG. 10 is a schematic diagram showing an example of a registered route selection screen according to the present embodiment;

FIG. 11 is a schematic diagram showing an example of a route display screen according to the present embodiment; and

FIG. 12 is a flowchart showing a routine of a simplified display process according to the present embodiment.

### DETAILED DESCRIPTION OF EMBODIMENTS

Hereinafter, a parking support system according to the present embodiment will be described with reference to the drawings.

### Hardware Configuration

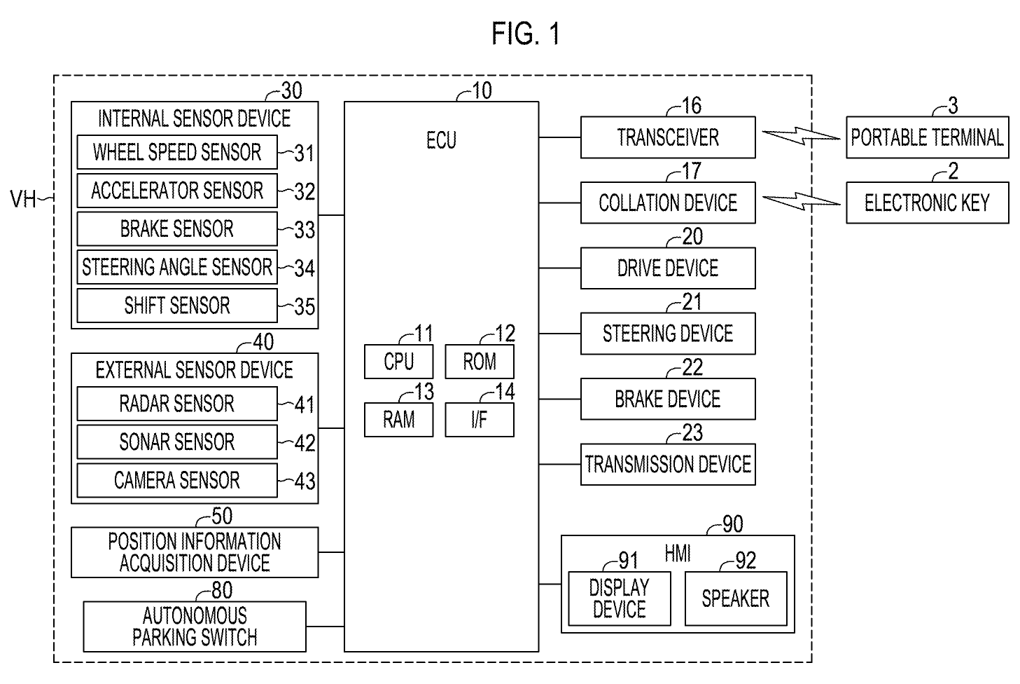

FIG. 1 is a schematic diagram showing a hardware configuration of the parking support system according to the present embodiment. As shown in FIG. 1, the parking support system includes an electronic control unit (ECU) 10, an electronic key 2, and a portable terminal 3. The ECU 10 is mounted in a vehicle VH. The ECU 10 includes a central processing unit (CPU) 11, a read only memory (ROM) 12, a random access memory (RAM) 13, an interface device 14, and the like. The CPU 11 is a processor that executes various programs stored in the ROM 12. The ROM 12 is a non-volatile memory that stores data and the like necessary for the CPU 11 to execute various programs. The RAM 13 is a volatile memory that provides a work area that is used in a case where various programs are executed by the CPU 11. The interface device 14 is a communication device for communicating with an external device.

A transceiver 16, a collation device 17, a drive device 20, a steering device 21, a brake device 22, a transmission device 23, and the like are communicably connected to the ECU 10. Further, an internal sensor device 30, an external sensor device 40, a position information acquisition device 50, an autonomous parking switch 80, a human machine interface (HMI) 90, and the like are communicably connected to the ECU 10.

The ECU 10 is a device that performs autonomous entry control of causing the vehicle VH to autonomously enter the parking area and autonomous exit control of causing the vehicle VH to autonomously exit the parking area. Hereinafter, the autonomous entry control and the autonomous exit control performed based on the stored registered route are collectively referred to as “route storage parking control”. In addition, the autonomous entry control and the autonomous exit control performed by the user through remote operation are collectively referred to as “remote parking control”. The route storage parking control is an example of a first parking support control of the present disclosure, and the remote parking control is an example of a second parking support control of the present disclosure.

The transceiver 16 is a communication module for performing short-range wireless communication with the portable terminal 3. In the present embodiment, for example, short-range wireless communication via Bluetooth (registered trademark) is performed.

The portable terminal 3 is a device used by the user to remotely operate the vehicle VH, and is possessed by the user. The portable terminal 3 is, for example, a smartphone, but is not limited thereto as long as the terminal can install an application described below, and may be, for example, a tablet terminal. The portable terminal 3 includes an ECU (not shown) and a communication unit that can transmit and receive a Bluetooth (registered trademark) signal.

In order for the user to use the portable terminal 3 as a device for remotely operating the vehicle VH, the following work is performed in advance. Specifically, first, an application for executing the remote parking control is installed in the portable terminal 3 (hereinafter, the application is also referred to as a “remote parking application”). Next, the portable terminal 3 and the vehicle VH are paired (devices that conform to the Bluetooth (registered trademark) standard are authenticated and connected to each other). Next, the vehicle VH to be operated is registered in the remote parking application. As a result, the portable terminal 3 is associated with the transceiver 16 as a terminal that can perform wireless communication.

The collation device 17 is set to be paired with the electronic key 2, and realizes so-called smart entry by performing wireless communication with the electronic key 2 via, for example, Bluetooth (registered trademark). The electronic key 2 is not limited to the smart key system, and may be a digital key system in which a smartphone possessed by the user is used as a key.

The drive device 20 generates a drive force transmitted to drive wheels of the vehicle VH. Examples of the drive device 20 include an electric motor and an engine. The steering device 21 applies a steering force to wheels of the vehicle VH. The brake device 22 applies a braking force to the wheels of the vehicle VH. The transmission device 23 is configured to be selectively switched to a parking P that locks the rotation of the drive wheels, a reverse R that causes the vehicle VH to drive backward, a neutral N that blocks the transmission of power, and a drive D that causes the vehicle VH to drive forward.

The internal sensor device 30 is a sensor that detects a state of the vehicle VH. Specifically, the internal sensor device 30 includes a wheel speed sensor 31, an accelerator sensor 32, a brake sensor 33, a steering angle sensor 34, a shift sensor 35, and the like. The wheel speed sensor 31 detects a driving speed of the vehicle VH, that is, a vehicle speed. The accelerator sensor 32 detects an operation amount of an accelerator pedal (not shown) by the driver. The brake sensor 33 detects an operation amount of a brake pedal (not shown) by the driver. The steering angle sensor 34 detects a rotation angle of a steering wheel or a steering shaft (not shown), that is, a steering angle. The shift sensor 35 detects a shift position (parking P, reverse R, neutral N, drive D) of the transmission device 23. The internal sensor device 30 transmits the state of the vehicle VH detected by each of the sensors 31 to 35 to the ECU 10 at a predetermined cycle.

The external sensor device 40 is a sensor that recognizes object information related to an object around the vehicle VH. Specifically, the external sensor device 40 includes a radar sensor 41, a sonar sensor 42, a camera sensor 43, and the like.

The radar sensor 41 includes a millimeter wave radar and a lidar. The millimeter wave radar acquires a relative distance, a relative speed, and the like between the vehicle VH and the object by transmitting a radio wave in a millimeter wave band and receiving a reflected wave reflected by the object present in a radiation range. The lidar acquires a shape of the object, a relative distance, a relative speed, and the like between the vehicle VH and the object by sequentially scanning a plurality of directions with pulsed laser light having a wavelength shorter than the millimeter wave and receiving reflected light reflected by the object. The sonar sensor 42 acquires a relative distance, a relative speed, and the like between the vehicle VH and the object by transmitting an ultrasonic wave and receiving a reflected wave reflected by the object present in a radiation range. The camera sensor 43 is, for example, a stereo camera or a monocular camera, and a digital camera having an imaging element such as a CMOS or a CCD can be used. The camera sensor 43 acquires a shape of the object, a relative distance, a relative speed, and the like between the vehicle VH and the object by processing captured image data. The external sensor device 40 transmits the acquired object information to the ECU 10 at a predetermined cycle. The external sensor device 40 is not necessarily required to include all of the radar sensor 41, the sonar sensor 42, and the camera sensor 43, and may include, for example, only the camera sensor 43.

The position information acquisition device 50 acquires current position information of the vehicle VH. As the position information acquisition device 50, for example, a global positioning system (GPS), a global navigation satellite system (GNSS), or the like provided in a navigation device (not shown) can be used. The position information acquisition device 50 transmits the acquired current position information of the vehicle VH to the ECU 10 at a predetermined cycle.

The autonomous parking switch 80 is a switch that is provided, for example, in a center console, an instrument panel, or the like of the vehicle VH and is turned on and off by the user (for example, the driver) of the vehicle VH. In a case where the autonomous parking switch 80 is turned on, the ECU 10 receives a parking support request from the user. Here, the parking support request means a support request for the autonomous entry control or the autonomous exit control in a case of the route storage parking control, and means a support request for the autonomous entry control in a case of the remote parking control. The autonomous parking switch 80 is not limited to a physical switch, and may be a screen display type in which a button displayed on a display device 91 described below is selected by a touch operation or a dial operation. Alternatively, the automatic parking switch 80 may be a voice recognition type in which a voice of the driver is picked up by a voice pickup microphone of the vehicle or the portable terminal 3.

The HMI 90 is an interface for inputting and outputting information between the ECU 10 and the user, and includes an input device and an output device. Examples of the input device include a touch panel, a switch, and a voice pickup microphone. Examples of the output device include a display device 91 and a speaker 92. The display device 91 is, for example, a center display, a multi-information display, a head-up display, or the like. The speaker 92 is, for example, a speaker of an audio system or a navigation system.

### Software Configuration

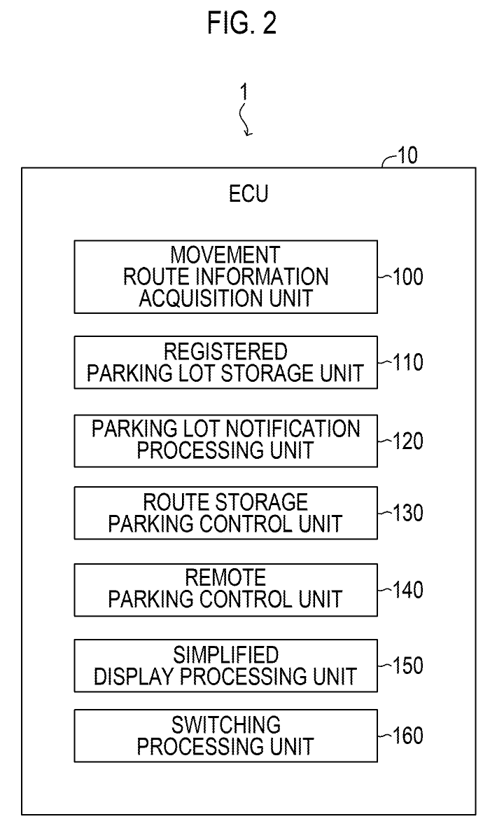

FIG. 2 is a schematic diagram showing a software configuration of the parking support system according to the present embodiment. As shown in FIG. 2, the ECU 10 includes a movement route information acquisition unit 100, a registered parking lot storage unit 110, a parking lot notification processing unit 120, and a route storage parking control unit 130 as functional elements. The ECU 10 further includes a remote parking control unit 140, a simplified display processing unit 150, and a switching processing unit 160 as functional elements. Each of the functional elements 100 to 160 is realized by the CPU 11 of the ECU 10 reading out and executing a program stored in the ROM 12 in the RAM 13. All or a part of the functional elements 100 to 160 can be provided in another ECU separate from the ECU 10 or in an information processing device of a facility (management center or the like) that can communicate with the vehicle VH.

### Route Storage Parking Control

In a case where the movement route information acquisition unit 100 receives a registration start request from the user (for example, the driver), the movement route information acquisition unit 100 acquires movement route information of the vehicle VH in a case where the user manually operates the vehicle VH to enter a predetermined parking area or to exit the predetermined parking area, and temporarily stores the acquired movement route information in the RAM 13. The registration start request of the user may be acquired by, for example, an operation of a touch-type switch image displayed on the display device 91, an operation of a physical switch provided separately from the display device 91, or voice recognition by a microphone.

The movement route information acquired by the movement route information acquisition unit 100 includes not only the movement route actually traveled by the vehicle VH but also operation information such as the shift position. The movement route of the vehicle VH refers to a movement trajectory of a vehicle position that changes with the driving of the vehicle VH. The vehicle position is, for example, a predetermined geometric center position of the vehicle VH in a plan view. The vehicle position may be another position (for example, a center position of right and left front wheels or a center position of right and left rear wheels) of the vehicle VH. In a case where the movement route information acquisition unit 100 receives the registration start request from the user, the movement route information acquisition unit 100 sets the position information of the vehicle VH at that time as a start position of the movement route. The position information of the vehicle VH may be acquired based on a detection result of the position information acquisition device 50. In a case where the start position is set, the movement route information acquisition unit 100 sets, for example, a two-dimensional map in which the start position is an origin, a front-rear direction of the vehicle VH is an X-axis, and a width direction of the vehicle VH is a Y-axis.

In a case where the user starts the manual operation of the vehicle to enter or exit the parking area from the start position, the movement route information acquisition unit 100 plots the movement trajectory of the vehicle position on the two-dimensional map for each predetermined sampling cycle. As a result, the movement route of the vehicle VH can be acquired. The movement trajectory may be calculated by, for example, odometry based on the detection results of the wheel speed sensor 31 or the steering angle sensor 34. Alternatively, the movement trajectory may be used in combination with the position information of the vehicle VH acquired by the position information acquisition device 50. Alternatively, the movement trajectory can also be estimated based on optical flow or the like from image data of a road surface around the vehicle VH captured by the camera sensor 43. The predetermined sampling cycle may be any of a predetermined distance or a predetermined time.

In a case of plotting the movement trajectory of the vehicle position on the two-dimensional map, the movement route information acquisition unit 100 acquires the shift position or the like detected by the internal sensor device 30 in association with the vehicle position on the movement route. In a case where the user stops the vehicle VH at a predetermined position and switches the shift position of the transmission device 23 to the parking P, the movement route information acquisition unit 100 ends the acquisition of the movement route information. The movement route information acquisition unit 100 sets the vehicle position at the time of ending the acquisition of the movement route information as an end position of the movement route.

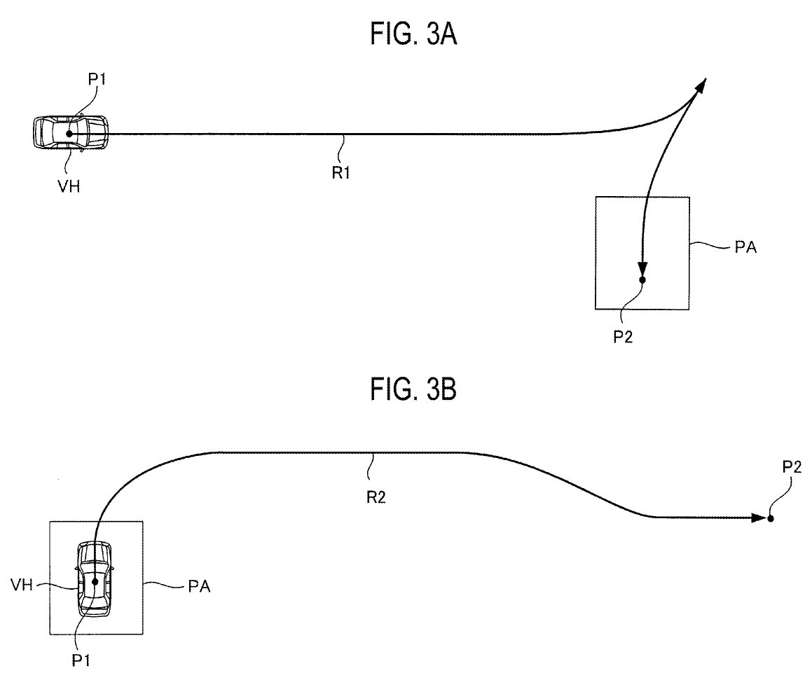

FIGS. 3A and 3B are schematic diagrams showing examples of the movement route acquired by the movement route information acquisition unit 100. FIG. 3A is an example of an entry time movement route R1 acquired by the movement route information acquisition unit 100 in a case where the user causes the vehicle VH to enter a predetermined parking area PA. FIG. 3B is an example of an exit time movement route R2 acquired by the movement route information acquisition unit 100 in a case where the user causes the vehicle VH to exit the predetermined parking area PA. In FIGS. 3A and 3B, reference numeral P1 indicates a start position, and reference numeral P2 indicates an end position.

The registered parking lot storage unit 110 stores the entry time movement route R1 acquired by the movement route information acquisition unit 100 as an entry time registered route RT1 used for the route storage parking control. In addition, the registered parking lot storage unit 110 stores the exit time movement route R2 acquired by the movement route information acquisition unit 100 as an exit time registered route RT2 used for the route storage parking control. In addition, the registered parking lot storage unit 110 stores the entry time registered route RT1 and the exit time registered route RT2 in association with the position information of the parking area PA. The position information of the parking area PA may be acquired based on the detection result of the position information acquisition device 50. In a case where there is a plurality of registered parking lots, the registered parking lot storage unit 110 stores the entry time registered route RT1, the exit time registered route RT2, and the like for each of the registered parking lots.

Further, the registered parking lot storage unit 110 stores the entry time registered route RT1 and the exit time registered route RT2 in association with parking area identification information LA1 and an entry-exit method identification information LA2. The parking area identification information LA1 is a name of the parking area PA that can be optionally input by the user through the HMI 90, and examples thereof include “home parking lot 1”, “home parking lot 2”, and “workplace parking lot”. The entry-exit method identification information LA2 is a method of entering or exiting the vehicle VH by the user through the manual operation in a case of the route storage, and examples thereof include information such as “garage right” or “garage left” indicating an exit direction, and “parallel parking” or “row parking” indicating an entry method.

In a case where a distance between the current position of the vehicle VH and the registered parking lot is equal to or less than a predetermined distance, the parking lot notification processing unit 120 executes a parking lot notification process of notifying the user of the vehicle VH that the registered parking lot is detected. The current position of the vehicle VH may be acquired based on the detection result of the position information acquisition device 50. The notification to the user may be performed by, for example, display on the display device 91 or a voice from the speaker 92.

In a case where the parking lot notification processing unit 120 executes the parking lot notification process and the autonomous parking switch 80 is turned on by the user of the vehicle VH, the route storage parking control unit 130 performs the route storage parking control. In this case, the route storage parking control of autonomously operating the drive device 20, the steering device 21, the brake device 22, and the transmission device 23 of the vehicle VH is executed based on the entry time registered route RT1 or the exit time registered route RT2 stored in the registered parking lot storage unit 110. The route storage parking control is executed, for example, by performing feedback control of the operation of the drive device 20, the steering device 21, or the like based on a deviation between the entry time registered route RT1 or the exit time registered route RT2 and an actual movement trajectory of the vehicle VH. The actual movement trajectory of the vehicle VH may be calculated by, for example, odometry based on the detection results of the wheel speed sensor 31 or the steering angle sensor 34. Alternatively, the actual movement trajectory of the vehicle VH may be estimated based on optical flow or the like from image data of a road surface around the vehicle VH captured by the camera sensor 43.

The route storage parking control unit 130 monitors whether an object that may come into contact with or collide with the vehicle VH is present based on the detection result of the external sensor device 40 while executing the route storage parking control. In a case where the object that may come into contact with or collide with the vehicle VH is detected, the route storage parking control unit 130 decelerates the vehicle VH or interrupts the route storage parking control. In a case where the vehicle VH reaches the end position P2 of the entry time registered route RT1 or the exit time registered route RT2, the route storage parking control unit 130 stops the vehicle VH. In a case where the shift position of the transmission device 23 is switched to the parking P, the route storage parking control unit 130 ends the route storage parking control.

### Remote Parking Control

The remote parking control unit 140 executes the remote parking control of autonomously driving the vehicle VH to enter the predetermined parking area or to exit the predetermined parking area in a state where the user gets off the vehicle VH. Hereinafter, the details of the remote parking control will be described with respect to the remote exit control. The parking support system can execute the forward exit and the backward exit in the remote exit control, but the forward exit will be described below, and the backward exit will not be described. In addition, the remote entry control is different from the remote exit control in that some operations are performed on the display device 91 of the vehicle, but since the basic process is the same as the remote exit control, description thereof will be omitted.

### Remote Exit Control

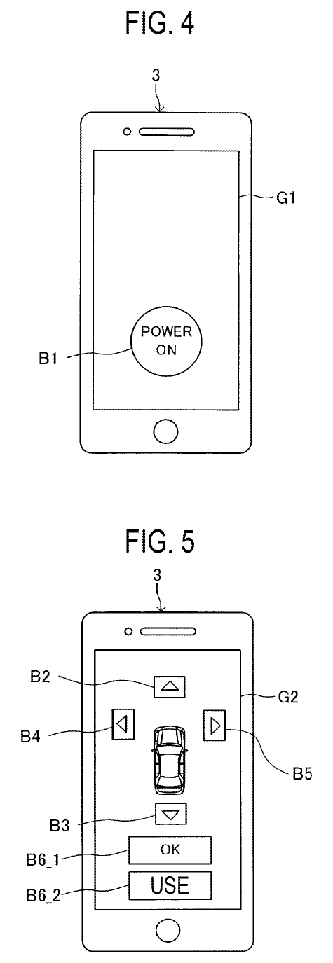

There is a case where the user who possesses the electronic key 2 and the portable terminal 3 approaches the vehicle VH within a predetermined distance range (for example, several meters), unlocks the door using the electronic key 2 (smartphone in the case of the digital key system), and starts the remote parking application of the portable terminal 3. In this case, the remote parking control unit 140 displays a power operation screen G1 shown in FIG. 4 on a display of the portable terminal 3 through the transceiver 16. The power operation screen G1 includes a power button B1. In a case where the user performs a touch operation on the power button B1, the remote parking control unit 140 turns on the power of the vehicle VH.

In a case where the power of the vehicle VH is turned on, the remote parking control unit 140 acquires the position of the vehicle VH with respect to the parking area in which the vehicle VH is parked based on the detection result of the external sensor device 40. In a case where the position of the vehicle VH with respect to the parking area is acquired, the remote parking control unit 140 acquires a direction (hereinafter, an exitable direction) in which the vehicle VH can be exited based on the detection result of the external sensor device 40.

In a case where the exitable direction is acquired, the remote parking control unit 140 displays an exit plan selection screen G2 shown in FIG. 5 on the display of the portable terminal 3 through the transceiver 16. The exit plan selection screen G2 includes a plurality of exit direction selection buttons B2, B3, B4, B5, an exit direction determination button B6_1, and a registered route use button B6_2. In the example shown in the drawing, a front selection button B2 indicating the forward exit, a rear selection button B3 indicating the backward exit, a left front selection button B4 indicating the left front exit, and a right front selection button B5 indicating the right front exit are displayed as the exit direction selection buttons. The exit direction determination button B6_1 is a button for the user to determine the exit direction selected from the exit direction selection buttons B2, B3, B4, B5. For example, in a case where the user performs a touch operation on the left front selection button B4 and then performs a touch operation on the exit direction determination button B6_1, the remote parking control unit 140 sets the left front as the designated exit direction. The registered route use button B6_2 is a button that is selected in a case where the user desires the remote exit support based on the exit time registered route RT2 stored in the registered parking lot storage unit 110. Details of the process in a case where the user performs a touch operation on the registered route use button B6_2 (that is, in a case where the request is received) will be described below.

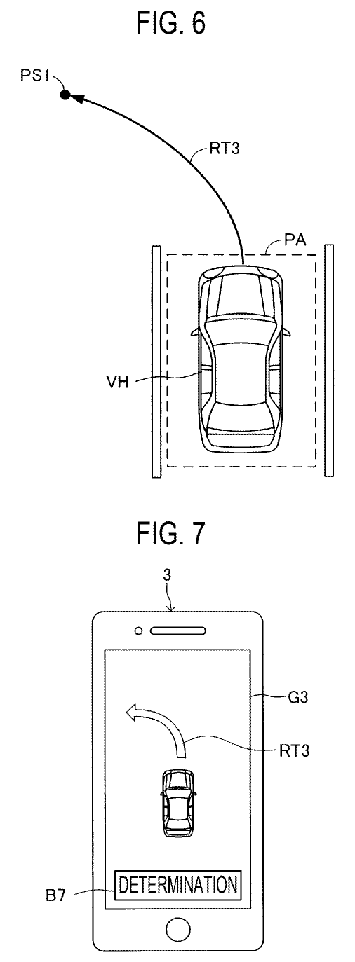

In a case where the designated exit direction is set, the remote parking control unit 140 sets a target route RT3 at the time of the remote exit based on the detection result of the external sensor device 40. As shown in FIG. 6, the target route RT3 is a route on which the vehicle VH drives from the parking area PA to a target stop position PS1 in the designated exit direction. FIG. 6 shows an example in which the left front is set as the designated exit direction.

In a case where the target route RT3 is set, the remote parking control unit 140 displays an exit plan confirmation screen G3 shown in FIG. 7 on the display of the portable terminal 3 through the transceiver 16. The exit plan confirmation screen G3 includes, for example, the target route RT3 and an exit plan determination button B7. In a case where the user performs a touch operation on the exit plan determination button B7, the remote parking control unit 140 ends the setting process of the exit plan.

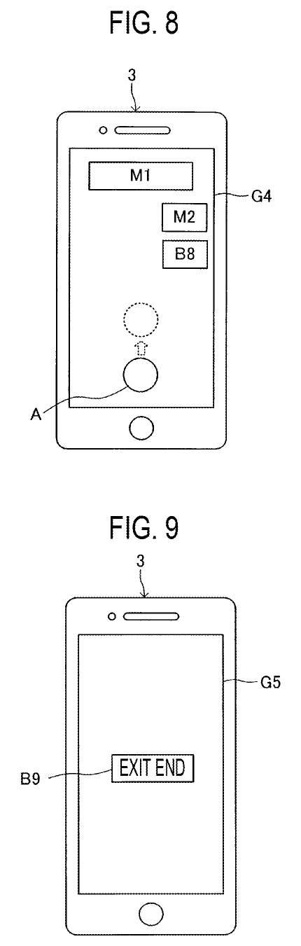

In a case where the setting process of the exit plan is ended, the remote parking control unit 140 displays an exit operation screen G4 shown in FIG. 8 on the display of the portable terminal 3 through the transceiver 16. The exit operation screen G4 includes a message M1 to be notified to the user, an operation button A to be operated by the user, a remaining distance display M2, and a boarding button B8. As the message M1, for example, a sentence such as “please check the safety around and move the vehicle” is displayed. The remaining distance display M2 is a distance from the current position to the target stop position PS1 of the vehicle VH. The boarding button B8 is a button for the user to indicate the intention to get on the vehicle VH after ending the exit support.

There is a case where the user holds the operation button A displayed on the display of the portable terminal 3 by sliding (see a broken line arrow) upward on the screen while pressing the operation button A for a long time. In this case, the remote parking control unit 140 controls the operation of the drive device 20, the steering device 21, the brake device 22, and the like based on the detection results of the internal sensor device 30 and the external sensor device 40. Therefore, the remote exit drive control of autonomously driving the vehicle VH along the target route RT3 is started. In a case where the remote exit drive control is started, the remote parking control unit 140 sequentially calculates the movement trajectory of the vehicle VH. In addition, the remote parking control unit 140 calculates the remaining distance until the vehicle VH reaches the target stop position PS1 based on the movement trajectory sequentially calculated during the execution of the exit drive control, and displays the remaining distance on the remaining distance display M2. The movement trajectory may be calculated by, for example, odometry based on the detection results of the wheel speed sensor 31 or the steering angle sensor 34. Alternatively, for example, the movement trajectory can also be estimated based on optical flow or the like from image data of a road surface around the vehicle VH captured by the camera sensor 43.

In a case where the user moves a finger from the display of the portable terminal 3 during the execution of the remote exit drive control, the remote parking control unit 140 interrupts the remote exit drive control. In a case where the user performs a touch operation on the boarding button B8 after moving the finger from the display of the portable terminal 3, the remote parking control unit 140 displays an exit end confirmation screen G5 shown in FIG. 9 on the display of the portable terminal 3 through the transceiver 16. The exit end confirmation screen G5 includes an exit end button B9. In a case where the user performs a touch operation on the exit end button B9, the remote parking control unit 140 ends the remote exit control.

### Simplified Display Process and Switching Process

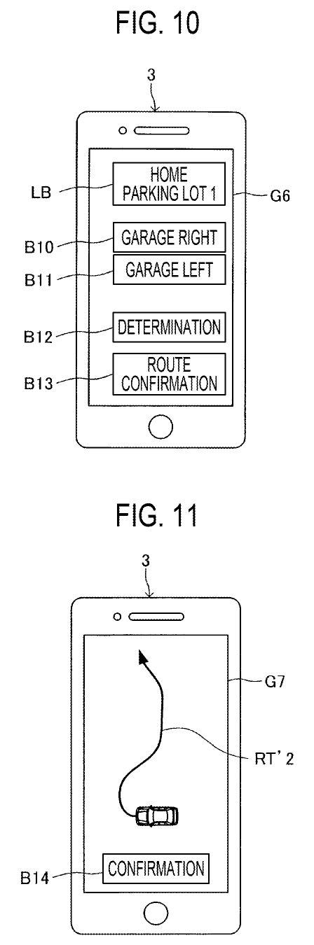

There is a case where the user performs a touch operation on the registered route use button B6_2 on the exit plan selection screen G2 shown in FIG. 5. In this case, the simplified display processing unit 150 executes a simplified display process of simplifying various types of information for the user to understand the exit time registered route RT2 (entry time registered route RT1 in a case of the remote entry control) and displaying the simplified information on the display of the portable terminal 3. Specifically, in a case where the user performs a touch operation on the registered route use button B6_2, the simplified display processing unit 150 displays a registered route selection screen G6 shown in FIG. 10 on the display of the portable terminal 3 through the transceiver 16.

The registered route selection screen G6 includes a parking lot label LB, entry-exit method selection buttons B10, B11, an exit determination button B12, and a route confirmation button B13. The parking lot label LB represents the parking area identification information LA1 associated with the parking area PA in which the vehicle VH is currently stopped. The entry-exit method selection buttons B10, B11 represent the entry-exit method identification information LA2 associated with the parking area PA. In a case where a plurality of pieces of entry-exit method identification information LA2 are associated with the parking area PA, a plurality of entry-exit method selection buttons B10, B11 corresponding to the pieces of entry-exit method identification information LA2 are displayed. In the example shown in FIG. 10, “home parking lot 1” is displayed as the parking lot label LB1, and “garage right” and “garage left” are displayed as the entry-exit method selection buttons B10, B11.

The user may perform a touch operation on, for example, the entry-exit method selection button B10 representing “garage right” among the entry-exit method selection buttons B10, B11 of the registered route selection screen G6, and then perform a touch operation on the exit determination button B12. In this case, the switching processing unit 160 executes the switching process of switching the target route RT3 used for the remote exit control by the remote parking control unit 140 to the exit time registered route RT2. The exit time registered route RT2 is stored in the registered parking lot storage unit 110 in association with the entry-exit method identification information LA2 of “garage right”. The flow of the subsequent remote exit control is as described above with reference to FIGS. 8 and 9.

In the present embodiment, as described above, the minimum information for the user to understand the name of the parking area PA registered as the registered parking lot and the exit method, such as the parking area identification information LA1 (parking lot label LB) and the entry-exit method identification information LA2 (exit method selection buttons B10, B11), is displayed on the portable terminal 3. Therefore, it is possible to effectively suppress the amount of data of the wireless communication as compared with a case where the information on the exit time registered route RT2 stored in the registered parking lot storage unit 110 is transmitted and displayed as it is on the portable terminal 3.

Here, in some cases, the user may not be able to sufficiently understand the parking lot label LB and the entry-exit method selection buttons B10, B11 only with the display. The user performs a touch operation on, for example, the entry-exit method selection button B10 representing “garage right” on the registered route selection screen G6, and then performs a touch operation on the route confirmation button B13. Then, the simplified display processing unit 150 displays a route display screen G7 shown in FIG. 11 on the display of the portable terminal 3 through the transceiver 16. The route display screen G7 includes, for example, a route (hereinafter, a simplified registered route RT2’) obtained by simplifying the exit time registered route RT2 and a confirmation button B14.

Here, a process of generating the simplified registered route RT2’ will be described. First, the simplified display processing unit 150 extracts a representative point from a point group of the exit time registered route RT2 stored in the registered parking lot storage unit 110 (representative point extraction process). Here, examples of the representative point include a start position P1, an end position P2, a start point or an end point of a curve having a predetermined curvature or more at which the traveling direction of the vehicle VH changes, and an intermediate point. In addition, the simplified display processing unit 150 extracts the current position of the vehicle VH on the same coordinate system as the exit time registered route RT2 (current position extraction process). In a case where the representative point and the current position of the vehicle VH are extracted, the simplified display processing unit 150 normalizes the coordinates of the representative point and the current position to the display coordinate of the portable terminal 3, and transmits the normalized coordinates to the portable terminal 3 through the transceiver 16 (normalization transmission process). As a result, the route display screen G7 including the simplified registered route RT2’ is displayed on the display of the portable terminal 3. There is a case where the user performs a touch operation on the confirmation button B14 of the route display screen G7. In this case, the switching processing unit 160 executes the switching process of switching the target route RT3 used for the remote exit control by the remote parking control unit 140 to the exit time registered route RT2 stored in the registered parking lot storage unit 110. The flow of the subsequent remote exit control is as described above with reference to FIGS. 8 and 9.

In the present embodiment, as described above, in a case where the user requests the confirmation of the route, the simplified registered route RT2’ obtained by simplifying the exit time registered route RT2 stored in the registered parking lot storage unit 110 is generated and displayed on the display of the portable terminal 3. Therefore, it is possible to effectively suppress the amount of data of the wireless communication as compared with a case where the information (for example, all the coordinate position information) on the exit time registered route RT2 stored in the registered parking lot storage unit 110 is transmitted and displayed as it is on the portable terminal 3.

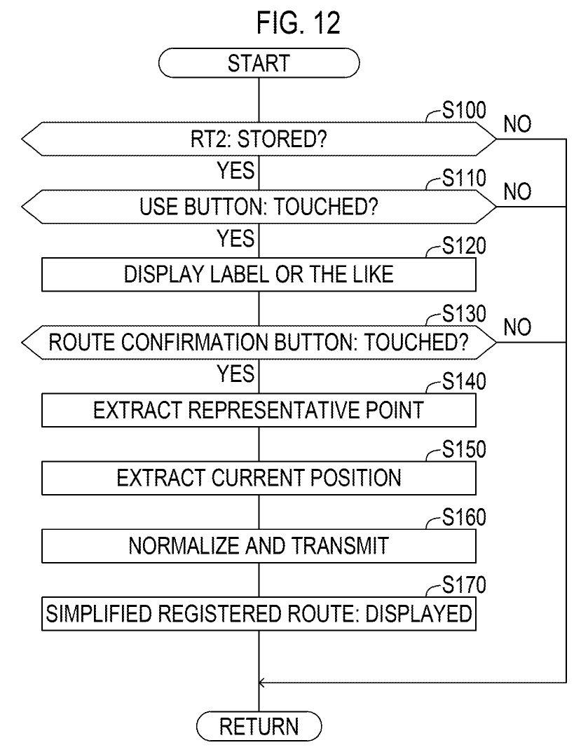

Next, a routine of the simplified display process executed by the CPU 11 of the ECU 10 will be described with reference to the flowchart shown in FIG. 12. There is a case where the user unlocks the door using the electronic key 2 (smartphone in the case of the digital key system), starts the remote parking application of the portable terminal 3, and turns on the power of the vehicle VH by operating the power operation screen G1. In this case, the present routine is started.

In S100, the ECU 10 determines whether the at least one or more exit time registered routes RT2 (entry time registered routes RT1 in a case of the remote entry control) are stored. There is a case where one or more exit time registered routes RT2 are stored (Yes). In this case, the ECU 10 proceeds to the process of S110. On the other hand, in a case where the exit time registered route RT2 is not stored (No), the ECU 10 returns from the present routine.

In S110, the ECU 10 determines whether the user has performed the touch operation on the registered route use button B6_2 on the exit plan selection screen G2 (see FIG. 5). In a case where the user has performed the touch operation on the registered route use button B6_2 (Yes), the ECU 10 proceeds to the process of S120. On the other hand, in a case where the user does not perform the touch operation on the registered route use button B6_2 (No), the ECU 10 returns from the present routine.

In S120, the ECU 10 displays the registered route selection screen G6 (see FIG. 10) including the parking lot label LB representing the parking area identification information LA1 associated with the parking area PA in which the vehicle VH is currently stopped on the display of the portable terminal 3. The registered route selection screen G6 further includes the entry-exit method selection buttons B10, B11 representing the entry-exit method identification information LA2 associated with the parking area PA.

Next, in S130, the ECU 10 determines whether the user has performed the touch operation on the route confirmation button B13 on the registered route selection screen G6 (see FIG. 10). In a case where the user has performed the touch operation on the route confirmation button B13 (Yes), the ECU 10 proceeds to the process of S140. On the other hand, in a case where the touch operation is not performed on the route confirmation button B13 (No), the ECU 10 returns from the present routine.

In S140, the ECU 10 extracts the representative point from the point group of the exit time registered route RT2. Next, in S150, the ECU 10 extracts the current position of the vehicle VH on the same coordinate system as the exit time registered route RT2. Next, in S160, the ECU 10 normalizes the coordinates of the representative point and the current position to the display coordinate of the portable terminal 3, and transmits the normalized coordinates to the portable terminal 3 through the transceiver 16. In S170, the ECU 10 displays the route display screen G7 including the simplified registered route RT2’ on the display of the portable terminal 3. Thereafter, the ECU 10 returns from the present routine.

The present disclosure is not limited to the embodiment, and various modifications can be made without departing from the object of the present disclosure.

For example, in the embodiment, the process of simplifying the exit time registered route RT2 to generate the simplified registered route RT2’ has been described as being executed in a case where the user performs the touch operation on the route confirmation button B13 of the registered route selection screen G6. However, the simplified registered route RT2’ may be generated in advance in a case of storing the exit time registered route RT2 in the registered parking lot storage unit 110. In addition, in the embodiment, the simplified display process has been described as being applied to the remote exit control as an example, but the simplified display process can also be applied to the remote entry control. In this case, for example, the route display screen G7 or the like may be displayed on the display of the portable terminal 3 at a timing when the user starts the remote parking application of the portable terminal 3 after getting off the vehicle VH.

What is claimed is:

1. A parking support system configured to execute:
first parking support control of storing, as a registered route, a movement route of a vehicle in a case of causing the vehicle to enter a parking area that is predetermined or exit the parking area by a manual operation of a user, in association with the parking area, and autonomously driving the vehicle along the registered route in a case of causing the vehicle to enter the parking area or exit the parking area in next and subsequent times to cause the vehicle to autonomously enter or exit the parking area; and
second parking support control of autonomously driving the vehicle along a target route in response to an operation of a portable terminal of the user to cause the vehicle to autonomously enter the parking area or autonomously exit the parking area, wherein:
the registered route is stored in association with identification information with which the user is able to identify the parking area;
in a case where a use request for the registered route from the user is received in a case where the user causes the vehicle to enter the parking area or exit the parking area by the second parking support control, the second parking support control is executed by using the registered route as the target route; and
in a case where the use request from the user is received, the identification information is displayed on a screen of the portable terminal.

2. The parking support system according to claim 1, wherein
the identification information includes a name of the parking area input by the user in a case of storing the registered route in association with the parking area, and an exit method in a case of causing the vehicle to exit the parking area or an entry method in a case of causing the vehicle to enter the parking area by the manual operation of the user.

3. The parking support system according to claim 1, wherein in a case where the use request is received, the identification information is displayed and a simplified registered route generated by simplifying the registered route is displayed, on the screen of the portable terminal.

4. The parking support system according to claim 3, wherein the simplified registered route is generated by extracting at least a start position, an end position, and a position at which a traveling direction of the vehicle changes by a predetermined amount or more, from the registered route.
